(19) United States
(12) Patent Application Publication
(10) Pub. No.: US 2011/0251869 A1
(43) Pub. Date: Oct. 13, 2011

(54) SYSTEM AND METHOD FOR DETECTING FRAUDULENT AFFILIATE MARKETING IN AN ONLINE ENVIRONMENT

(76) Inventor: Hagai Shekhter, Hallandale Beach, FL (US)

(21) Appl. No.: 13/082,554

(22) Filed: Apr. 8, 2011

Related U.S. Application Data
(60) Provisional application No. 61/322,506, filed on Apr. 9, 2010.

(51) Int. Cl. G06Q 10/00

(52) U.S. Cl. 705/7.28

(57) ABSTRACT

A method for monitoring merchant website transactions generated by affiliate marketing sources to detect fraudulent affiliate transactions involves obtaining transaction data for multiple on-line transactions, processing the transaction data using an affiliate separation module to separate the transactions based on affiliate identification, grouping the transaction data by affiliate source, analyzing all transactions corresponding to each affiliate using first algorithm that determines whether transaction data for each of said transactions matches pre-defined parameters that are consistent with fraudulent activity, determining the percentage of suspicious transactions relative to all transactions using a second algorithm, and identifying an affiliate as potentially fraudulent if said percentage of suspicious transactions exceeds a predetermined percentage.

### CROSS REFERENCE TO RELATED APPLICATIONS

This application claims the benefit of U.S. provisional patent application Ser. No. 61/322,506, filed on Apr. 9, 2010.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights.

### BACKGROUND OF THE INVENTION

1. Field of the Invention

The present invention relates to the detection of entities that are committing affiliate fraud by analysis of the traffic, transactions, and user behavior occurring on merchant websites.

2. Description of Related Art

Many online merchants and advertisers (hereinafter “merchants”) market their goods and services using marketing sources, often referred to as “affiliates,” to drive prospective purchasers to their website. When the prospective purchaser completes a transaction or other predetermined act, such as completing form, the merchant then pays the affiliate a fee for that transaction. This is viewed as a low risk approach for the merchant because it limits their risk since they only pay for a completed transaction. As used herein the term “transaction” is broadly construed to mean an actual sale, lead, or receipt of information (such as the filling in of a form), or any other useful exchange between the merchant and the prospective customer involving the affiliate. Affiliate marketing is often called performance marketing.

Since the affiliate gets paid for transactions that they generate for the merchant, there exists an incentive for the generation of fraudulent transactions. More particularly, it has been found that some affiliates are responsible for defrauding merchants by generating bogus transactions. For example, an affiliate may purchase products on the merchant's site using stolen credit card information. Or, the affiliate may fill out false “leads” on the merchant's website because it gets paid for every lead that it generates. As a result, the fraudulent affiliate receives commission payments from the merchant transactions that are mere fabrications and not otherwise genuine.

In response to such fraudulent activity, systems have been developed to detect fraudulent transactions. Fraud detection systems known in the art primarily rely on comparing the user entered data and with a database of “static” data such a database that indicates if the input data is true and correct based on publicly known information. For example, some fraud detection systems involving purchase transactions often attempt to detect fraudulent transactions by verifying the information that the user enters (e.g. credit card number, name address, etc.) against an external database of known stolen credit cards. If the user inputted credit card does not exist in the database of known stolen cards then that transaction is deemed to be non-fraudulent. This system, however, has inherent limitations, namely, the system will only identify the transaction as fraudulent if that credit card has been reported to that specific database as being stolen. Thus, in order for the transaction to be recognized as being fraudulent, the stolen card must have been previously used in another transaction wherein it was found to be stolen and then reported to the specific “stolen card database company” that the system references. In most cases, however, perpetrators of fraudulent transactions will use a new/freshly-stolen credit card that has yet to have been reported as stolen thereby rendering such systems virtually useless. Further, it is important to note that a “stolen card” does not necessarily mean that it was physically stolen. In many cases it's an identity theft situation where the true owner of the credit card does not yet know that their card was stolen. In such cases, the currently existing systems would not detect the fraud.

In the case where the transaction does not involve payment of any kind (e.g. when the transaction involves obtaining information, such as by filling out a form, or generating a lead) existing systems take the information that the user enters and attempts to match it up against an external database to confirm that the information is valid. If the system is able to validate the information, then that transaction is deemed non-fraudulent. For example, if a user enters John Smith, 123 Main Street, Hometown, State, phone number 888-888-8888, that information would be checked against a database to see if a John Smith really lives at 123 Main Street in that state and town and has that phone number. If the data matches, then the currently existing systems would assume that the transaction was non-fraudulent. This method, however, is also flawed since most perpetrators of fraud use “actual” data,” i.e. stolen identities, such that a database check confirms the information and no indication of fraud will be detected. Accordingly, such systems fail to adequately identify fraudulent transactions.

Thus, the fraud detection systems known in the art are limited as they attempt to identify individual fraudulent transactions on a transaction-by-transaction basis, and therefore are not directed to identifying affiliate fraud on a wider scale.

Accordingly, there exists a need for a system that monitors the total transactions from each affiliate marketing source and analyses the transactions separately from all other transactions that were sent from other affiliate sources for the purpose of detecting fraudulent transactions.

### BRIEF SUMMARY OF THE INVENTION

The present invention addresses the needs in the art by providing a system and method for monitoring merchant website transactions generated by affiliate marketing sources, and analyzing the transactions on a source-by-source (i.e. affiliate by affiliate) basis, and separate from all other transactions sent from other affiliate sources, for the purpose of detecting fraudulent transactions. The affiliate's transactions are analyzed for patterns that are consistent with fraudulent activity by focusing on patterns that suggest a single user is responsible for all (or most) of the transactions. In addition, the data is analyzed for patterns that consistently indicate a sharp contrast from the baseline behavioral patterns of “normal/legitimate” traffic. Some, but not all, of the data points that are analyzed include website visitor behavior, information derived from a user's browser, forms filled out, etc. By use of the present invention, an online merchant/advertiser is able to detect fraudulent affiliate activity before paying fees or commissions for fraudulent transactions.

The present invention thus provides advancements in the art of detecting fraudulent affiliate transactions in an on-line environment. In cases where the fraudulent transaction involves the generation of a form/lead based on fictitious information, detection of the fraud prevents the merchant from paying for otherwise useless leads and the time associated with attempting to capitalize on fraudulent leads. In cases where the fraudulent transaction involves the use of a stolen credit card, detection of the fraud prevents the merchant from loss of valuable goods and services. In addition, detection of the fraud assists in maintaining the merchant's credit card merchant accounts since such accounts are subject to termination if they are found to experience excessive fraudulent sales.

Accordingly, it is an object of the present invention to provide a fraud detection system and method for use to protect merchants from fraudulent transactions in an on-line environment.

Another object of the present invention is to provide such a system that monitors the totality of transactions from affiliate marketing sources and analyzes them on a source-by-source basis, and separate from all other transactions sent from other affiliate sources, for the purpose of detecting fraudulent transactions.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a block diagram illustrating use of a fraud detection system in accordance with the present invention to monitor a merchant's website for the purpose of detecting fraudulent transactions,

### DETAILED DESCRIPTION OF THE INVENTION

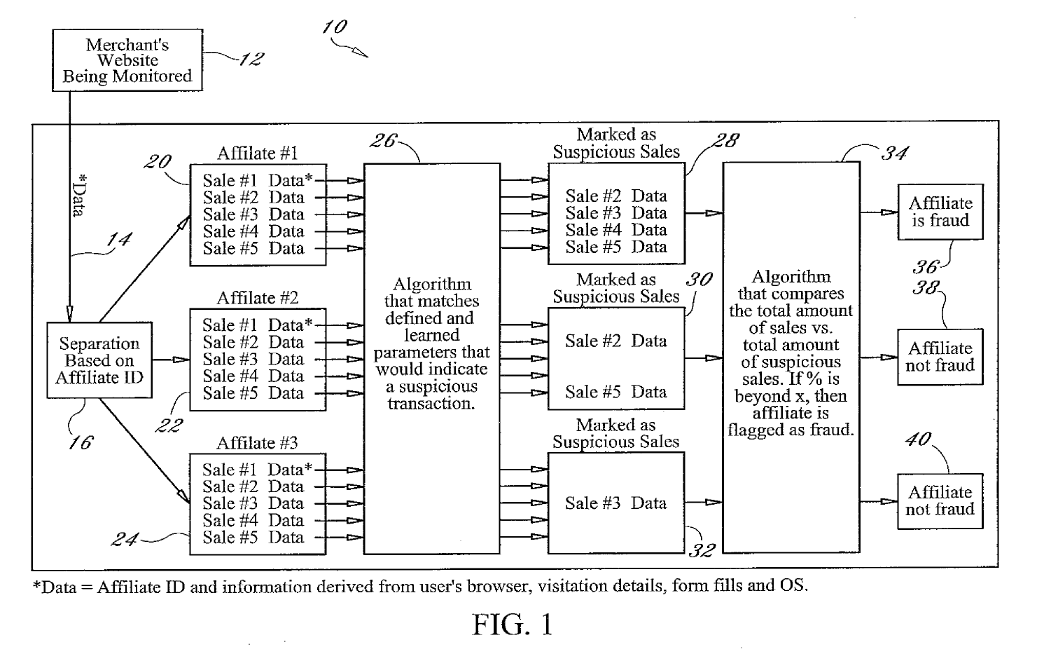

With reference now to the drawings, FIG. 1 depicts a block diagram illustrating a fraud detection system, generally referenced as 10, in accordance with the present invention. Fraud detection system 10 monitors a merchant website 12 for the purpose of detecting and preventing fraudulent affiliate transactions. In a preferred embodiment, transaction data 14 from the merchant website 12 is routed to fraud detection system 10. The transaction data typically includes the affiliate identification, as well user and transaction related information derived from the user's browser, visitation details, form fills etc. It should be noted that fraud detection system 10 may reside on the server hosting the merchant website, or may reside on a remote server.

The data streaming into fraud detection system 10 from each merchant web site 12, is processed by an affiliate separation module 16 that separates the data based on affiliate I.D, sub-ID and/or any other method that merchant uses to associate the transaction with the source it came from (the affiliate responsible for generating that transaction) as illustrated in FIG. 1. Accordingly, data for transactions occurring on merchant website 12 are compiled into groups for Affiliates A, B, and C, referenced as 20, 22, and 24 respectively. FIG. 1 illustrates a total of five (5) transactions for each of Affiliates A-C. Transactions are preferably accumulated and the analysis conducted periodically to ensure a representative sample of transactions. Once grouped by Affiliate source, the data is analyzed on an affiliate source-by-affiliate source basis, and separate from all other transactions sent from other affiliate sources, for the purpose of detecting fraudulent transactions. An algorithm looks for any matches between the affiliate data and pre-defined parameters that are consistent with fraudulent activity. In addition, the data is analyzed for patterns that consistently indicate a sharp contrast from the baseline behavioral patterns of “normal/legitimate” traffic. Some, but not all, of the data points that are analyzed include website visitor behavior, information derived from a user's browser, forms filled out, etc.

Transactions identified by algorithm 26 as being suspicious are identified for each affiliate and output from algorithm 26 as suspicious transactions 28, 30, and 32. The focus is on patterns that suggest a single user is responsible for all (or most) of the transactions. FIG. 1 illustrates that of the five transactions 20 are analyzed by algorithm 26 for Affiliate A. Transaction numbers 2-5 are identified by algorithm 26 as being suspicious as seen in block 28. Similarly, transaction numbers 2 and 5 were identified as suspicious in block 30 for Affiliate B, and only transaction number 3 was identified as suspicious in block 32 for Affiliate C. A second algorithm 34 then compares the total number of transactions with the total number of suspicious transactions. If the percentage of suspicious transactions reaches a predetermined level, then the affiliate is flagged as potentially fraudulent. As illustrated in FIG. 1, Affiliate A was identified as being fraudulent in block 36 due to the high percentage (80.0%) of suspicious transactions, whereas Affiliates B and C were not identified as fraudulent in blocks 38 and 40 respectively. The present invention thus provides a system and method for identifying potentially fraudulent affiliates by analysis of affiliate generated transactions. By allowing a merchant to identifying potentially fraudulent affiliates, the merchant can then take the appropriate steps to prevent being victimized by fraudulent transactions and thus avoid losses associated with such affiliates and transactions.

The instant invention has been shown and described herein in what is considered to be the most practical and preferred embodiment. It is recognized, however, that departures may be made there from within the scope of the invention and that obvious modifications will occur to a person skilled in the art.

What I claim is:

1. A method for monitoring merchant website transactions originating from affiliate marketing sources to detect fraudulent affiliate transactions, said method comprising:
obtaining, from a merchant website, transaction data for multiple on-line transactions, said transaction data including user data and the identification of the affiliate source associated with each said transaction;
processing said transaction data to separate the transactions by affiliate source;
grouping said transaction data by affiliate source;
analyzing all transactions within each group using a first algorithm search for predetermined consistencies associated with transactions within each group, and tagging any such transactions have said consistencies as suspicious;
determining the percentage of suspicious transactions within each group relative to all transactions within each group using a second algorithm; and
identifying an affiliate as potentially fraudulent if said percentage of suspicious transactions exceeds a predetermined percentage.

2. A method according to claim 1 wherein said predetermined consistencies are selected from a group including: user technical data, form data, and behavioral data.

3. A method for monitoring merchant website transactions originating from affiliate marketing sources to detect fraudulent affiliate transactions over a global computer network, said method comprising:
obtaining transaction data for multiple transactions occurring on a merchant website connected to the global computer network, said transaction data including user data and the identification of the affiliate source associated with each said transaction;
processing said transaction data using an affiliate separation software module to separate the transactions based on affiliate source;
grouping transactions by affiliate source;
analyzing all transactions within each group using a first algorithm that searches for predetermined consistencies indicative of fraudulent activity, and tagging any such transactions found to have said predetermined consistencies as suspicious;
for each group of transactions, determining the percentage of suspicious transactions relative to all transactions using a second algorithm; and
identifying an affiliate as potentially fraudulent if said percentage of suspicious transactions exceeds a predetermined percentage.

4. A method according to claim 3 wherein said predetermined consistencies are selected from elements of said transaction data from a group including: user technical data, form data, and behavioral data.
